(19) United States
(12) Patent Application Publication
(10) Pub. No.: US 2024/0259998 A1
(43) Pub. Date: Aug. 1, 2024

(54) METHODS FOR PAGING IN WIRELESS COMMUNICATION

(71) Applicant: ZTE Corporation, Shenzhen (CN)

(72) Inventors: Focai PENG, Shenzhen (CN); Mengzhu CHEN, Shenzhen (CN); Jun XU, Shenzhen (CN); Xuan MA, Shenzhen (CN); Lin LIN, Shenzhen (CN); Kai XIAO, Shenzhen (CN)

(21) Appl. No.: 18/429,883

(22) Filed: Feb. 1, 2024

Related U.S. Application Data
(63) Continuation of application No. PCT/CN2021/111199, filed on Aug. 6, 2021.

(51) Int. Cl. H04W 68/02; H04B 7/06; H04L 5/00; H04W 24/08

(52) U.S. Cl. CPC H04W 68/02; H04B 7/0626; H04L 5/0051; H04W 24/08

(57) ABSTRACT

Systems, apparatus and methods for wireless communication are described, and more specifically, to techniques related reducing power consumption during paging. One example method for wireless communication includes receiving, at a wireless device, paging configuration information associated with a paging message and monitoring for the paging message based on the paging configuration information. The paging configuration information can indicate a paging indication channel and/or a paging occasion. This method can reduce power consumption during paging by reducing the time that the wireless device monitors for the paging message

### CROSS REFERENCE TO RELATED APPLICATIONS

This patent document is a continuation of and claims benefit of priority to International Patent Application No. PCT/CN2021/111199, filed on Aug. 6, 2021. The entire content of the before-mentioned patent application is incorporated by reference as part of the disclosure of this application.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

This document relates to methods, systems, and devices for reducing power consumption during paging in mobile communication technology, including 5th Generation (5G), new radio (NR), 4th Generation (4G), and long-term evolution (LTE) communication systems.

In one exemplary aspect, a wireless communication method is disclosed. The method includes receiving, at a wireless device, paging configuration information associated with a paging message and monitoring for the paging message based on the paging configuration information.

In another exemplary aspect, a wireless communication method is disclosed. The method includes transmitting, by a network device, paging configuration information associated with a paging message and transmitting the paging message according to the paging configuration information.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE).

FIG. 2 shows an example paging cycle.

FIG. 3 shows an example paging cycle including a paging indication.

FIG. 4 shows an example paging early indication (PEI).

FIG. 5 shows an example bit field structure.

FIG. 6 shows an example bit field structure.

FIG. 7 shows an example bit field structure.

FIG. 8 shows an example bit field structure.

FIG. 9 shows an example bit field structure.

FIG. 10 shows an example method.

FIG. 11 shows an example method.

FIG. 12 is a block diagram representation of a portion of an apparatus that can be used to implement methods and/or techniques of the presently disclosed technology.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

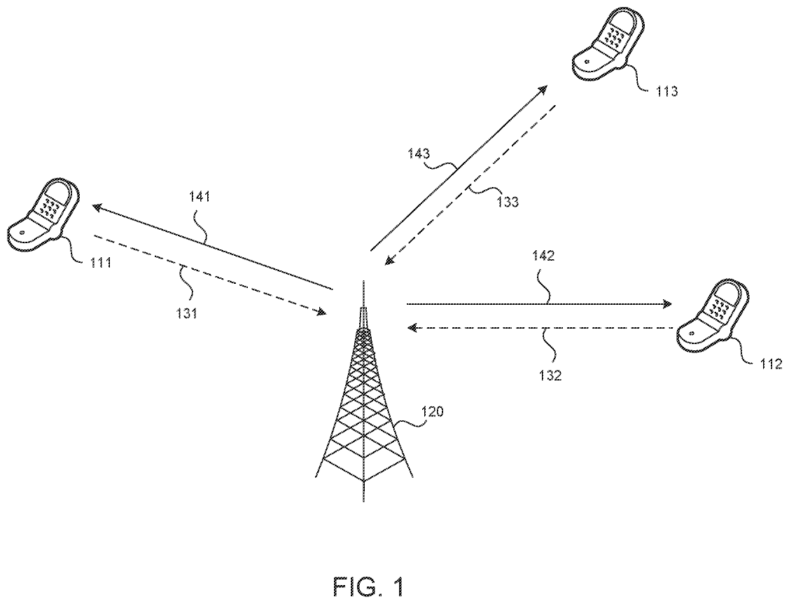

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

The present document uses section headings and sub-headings for facilitating easy understanding and not for limiting the scope of the disclosed techniques and embodiments to certain sections. Accordingly, embodiments disclosed in different sections can be used with each other. Furthermore, the present document uses examples from the 3GPP NR network architecture and 5G protocol only to facilitate understanding and the disclosed techniques and embodiments may be practiced in other wireless systems that use different communication protocols than the 3GPP protocols.

During a Paging Occasion (PO) of a paging cycle, a user equipment (UE) in a Radio Resource Control (RRC) Idle state (RRC_Idle) or RRC inactive state (RRC_Inactive) monitors a Physical Downlink Control Channel (PDCCH), which schedules paging message, even if no paging message is indicated for that particular UE. Similarly, a Physical Downlink Shared Channel (PDSCH) may not carry a paging message for that UE. Even so, the UE has to receive and decode PDCCH or PDSCH during a paging cycle. This operation consumes some unnecessary power.

During one PO, PDCCH may indicate that the UE has a paging message on PDSCH, for example if the network schedules multiple paging messages at once, but the content of the corresponding PDSCH does not include an actual paging message for the UE. This situation will also consume power unnecessarily.

In 5G, Discontinuous Reception (DRX) is a technology that does not require a UE to continuously receive signal or channel from a BS. The UE can intermittently receive a signal for a period of time and stop receiving for another period. One DRX cycle includes one ON duration of the DRX cycle (DRX-ON) and one OFF duration (DRX-OFF). For a UE in an RRC_Connected state, this UE will apply DRX in connected mode (C-DRX). For a UE in an RRC_Idle or RRC_Inactive state, this UE will apply DRX for idle mode (I-DRX).

For a UE in an RRC_Idle or RRC_Inactive state, the UE monitors for possible paging during a PO of each paging cycle. In one example, PDCCH does not schedule a paging message for the UE. In another example, PDCCH schedules a paging message for the UE, but the UE does not receive the PDSCH. In yet another example, PDCCH schedules a paging message, but the PDSCH does not carry a paging message for this particular UE. In each of these circumstances, methods are needed to reduce the UE's power consumption.

Prior to receiving a PO, a UE in an RRC_Idle or RRC_Inactive state detects a synchronization signal block (SSB) signal, which can be used for synchronization (SYNC) and automatic gain control (AGC). Typically, the period of SSB is 20 ms. When a PO is far away from SSB relative to the period, such as 19 ms, the UE must wake up early to receive the SSB to perform SYNC and AGC before the PO, which wastes energy.

Because of this, paging would be improved by sharing configuration information of channel state information reference signals (CSI-RSs) for UEs in an RRC_Connected state with a UE in an RRC_Idle or RRC_Inactive state. Currently, a UE is in an RRC_Idle or RRC_Inactive state has no knowledge of CSI-RSs that are configured for RRC_Connected UEs. However, sharing the configuration information of CSI-RS may produce a lot of signaling overhead. Thus, methods to reduce the overhead of delivering the CSI-RS configuration information are needed.

Introduced are methods that allow a UE to know more precisely whether it will receive a paging message, thus reducing unnecessary paging and UE power consumption.

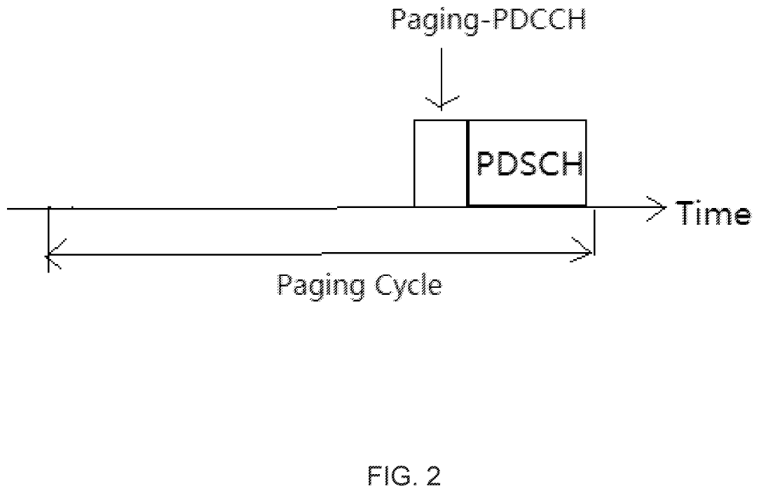

FIG. 2 shows an example paging cycle. In current NR, a UE in an RRC_Idle or RRC_Inactive state receives a paging message in every paging cycle. The paging message is carried on PDSCH, which is scheduled by the corresponding PDCCH (also “paging PDCCH”). However, the paging message may not be apply to the UE. That is, the paging message does not contain the 5th Generation System Temporary Mobile Subscription Identifier (5G-S-TMSI) of this UE. For this case, a false alarm occurs. This false alarm will waste energy of this UE. If the false alarm can be avoided, then the UE can save power.

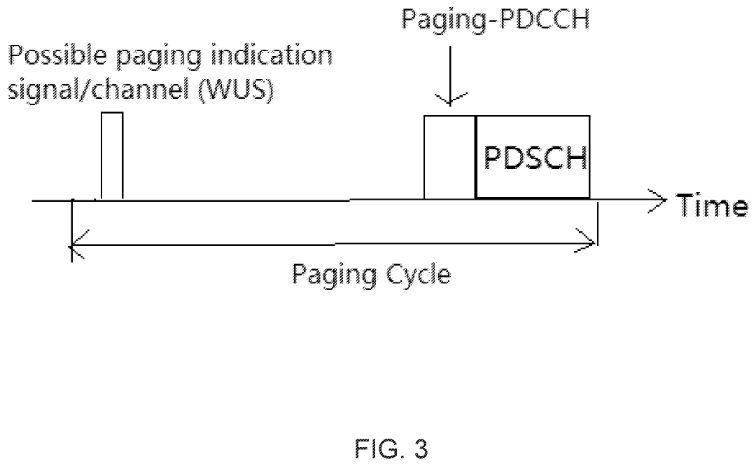

FIG. 3 shows an example paging cycle including a paging indication. Before the UE receives a paging message, paging indication information (also “paging configuration information”) can inform the UE that the UE can skip reception of the paging message, including skipping the paging PDCCH, thus avoiding a false alarm. The paging indication information can indicate a paging indication channel and/or a paging occasion. The paging indication information can be carried on a paging early indication (PEI) signal/channel, such as a wake-up signal/channel (WUS) and/or paging scheduling channel, such as paging-PDCCH.

### Example 1

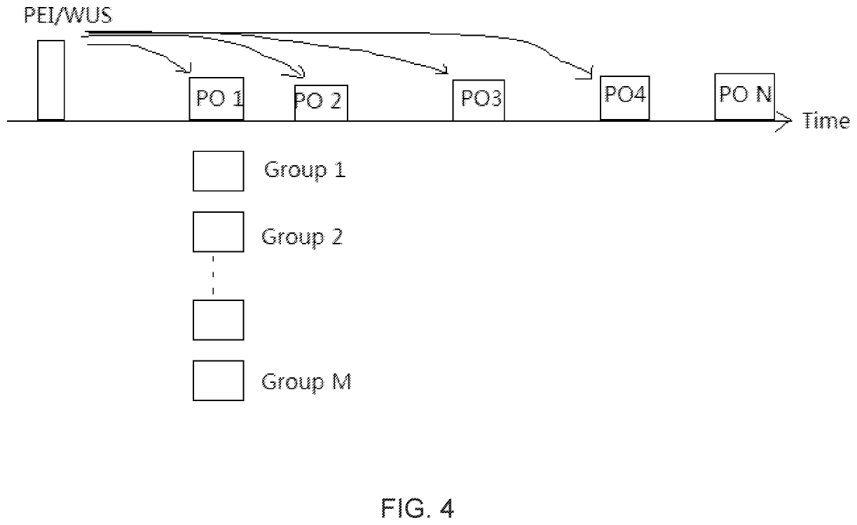

FIG. 4 shows an example PEI. If a PEI, such as WUS, is based on PDCCH, then there can be some bits for indication of a PO and/or PO group. As shown in FIG. 4, one PEI can indicate one PO or multiple POs. Each PO can include multiple PO groups.

One PEI can have N*M bits to indicate POs and PO groups, where N is the number of POs associated with the PEI, and M is the number of PO groups within a PO. The value of N and M can be configured by a higher layer, e.g., RRC layer. As the result, the PEI can have several kinds of bit field structures.

### Structure 1

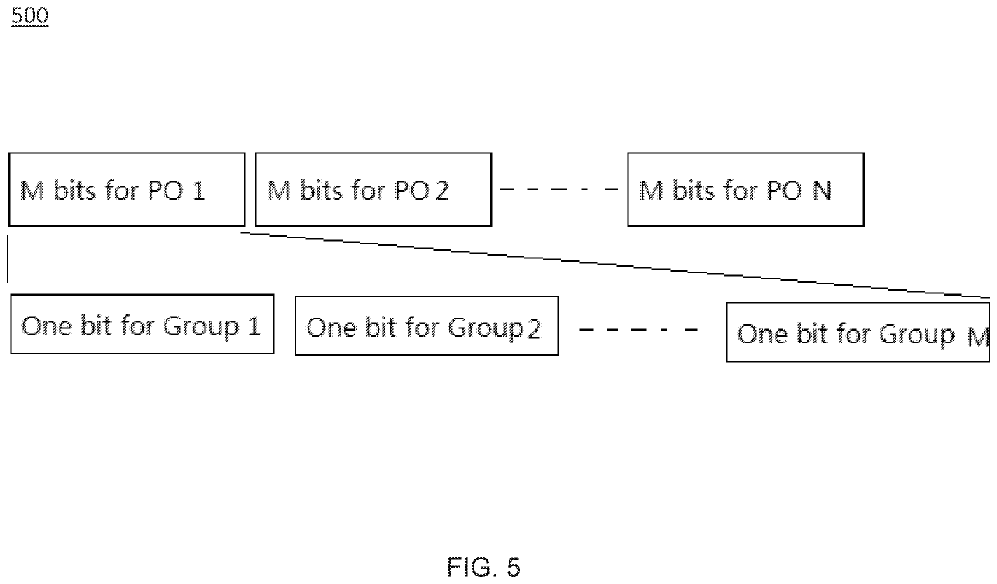

FIG. 5 shows an example bit field structure 500. The structure indicates N POs and uses N*M bits for M PO groups in each PO. With this structure, each group within a PO can have one bit. Thus, each PO and each group within a PO can be indicated separately. For example, if there are N=4 POs and M=8 groups within a PO, then there will be N*M=4*8=32 bits for PO indication. In some embodiments, if a bit is “1”, then the associated PO group is paged, and if the bit is “0,” then the PO group is note paged. In addition, a P bit cyclic redundancy check (CRC), e.g., P=8 or P=16 is enough for a target False Alarm Rate of 1%, can be attached after these indication bits.

It should be noted that, if no confusion were introduced, a group can be identical to a subgroup.

In some embodiments, different POs can have different numbers of groups (that is, different number of bits for groups). For example, PO 1 can have 4 groups (i.e., 4 bits) while PO 2 can have 8 groups (i.e., 8 bits). In addition, different group can also have different numbers of bits.

A paging occasion can include one or more monitoring occasions (MOs). One MO can include one paging-PDCCH. Similar to PEI/WUS, the paging indication information can also be included in a paging-PDCCH, including the bit field structure shown in FIG. 5

In some embodiments, a bit can be associated with an i-th group, and a bit “1” can represent that the i-th group is addressed or paged, where i=1, 2, . . . , M.

In some embodiments, the paging-PDCCH can carry bits for indication of POs and/or PO groups. The paging-PDCCH on PO can carry a bit structure for indication of a POs and/or PO groups, such as the structures disclosed herein. In some embodiments, both a PEI/WUS and paging-PDCCH on PO can carry bits for indication of POs and/or PO groups. In some embodiments, a PEI/WUS and paging-PDCCH can carry bits for indication of POs and/or PO groups at the same time.

### Structure 2

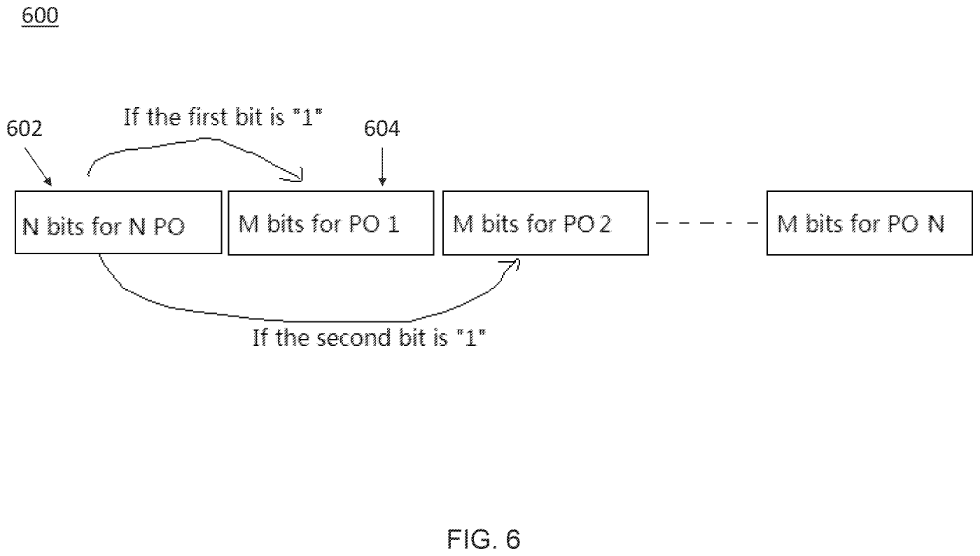

FIG. 6 shows an example bit field structure 600. The structure indicates N POs with a flexible N+N*M bits for group indication. In this structure, the first N bits comprising block 602 associated with N POs are always present, while the latter N*M bits might not present. If the i-th bit in the block 602 is “1”, then there can be a block of M bits corresponding to the i-th PO, where i=1, 2, . . . , N. Otherwise, e.g., if the i-th bit of block 602 is “0”, there is no M-bit block corresponding to the i-th bit. For example, if the first bit in block 602 is “1” (e.g., at least one group within PO 1 will be paged), then there can be a block 604 of M bits for PO 1, as shown in FIG. 6. Otherwise, there is no such block of M bits. For example, if N=3 POs and M=4 PO groups, there can be 3 or 7 or 11 or 15 bits in this block structure (i.e., N+1=4 possible bit field length).

In some embodiments, if the first bit in block is “0” (e.g., at least one group within PO 1 will be paged), then there can be a block of M bits for PO 1. Otherwise, there is no block of M-bits.

With this structure, the overhead of bit field length can be reduced while the coverage of PEI/WUS can be improved.

In some embodiments, this structure can be fixed. That is, no matter whether the i-th bit in block 602 is “1” or not, the corresponding block of M bits for the i=th PO is always present. In some embodiments, the M-bit block corresponding to a bit “0” in block 602 can serve as a virtual CRC when decoding (e.g., these M bits can all be set to zero).

In some embodiments, the states of the bits in block 602, such as the decimal value of the bits, can determine whether the corresponding i-th block is addressed or not. i=1, 2, . . . , N. This can be a fixed structure. For example, if there are M=4 paging groups, and the length of block 602 is N=log 2(M)=2, a value of “10” can indicate that the first 2 PO are will be paged because the decimal value of these 2 bits is 2, while any other POs are not addressed.

In this flexible structure, the number of blocks (i.e., N) and the number of groups (i.e., M) can be configured by higher layer (e.g., RRC layer). Alternatively, the value of N or M can be changed based on some condition. For example, if the number of POs per paging frame is four, then in the first PO, the N and M can be unchanged, but in the second, third, and fourth POs, the N and M can be changed as ½, ¼, and ⅛ of the original value, respectively. That is, a sub-set of N and/or M is selected. With this structure, the total number of bits can be reduced. improving the coverage of PEI/WUS.

### Structure 3

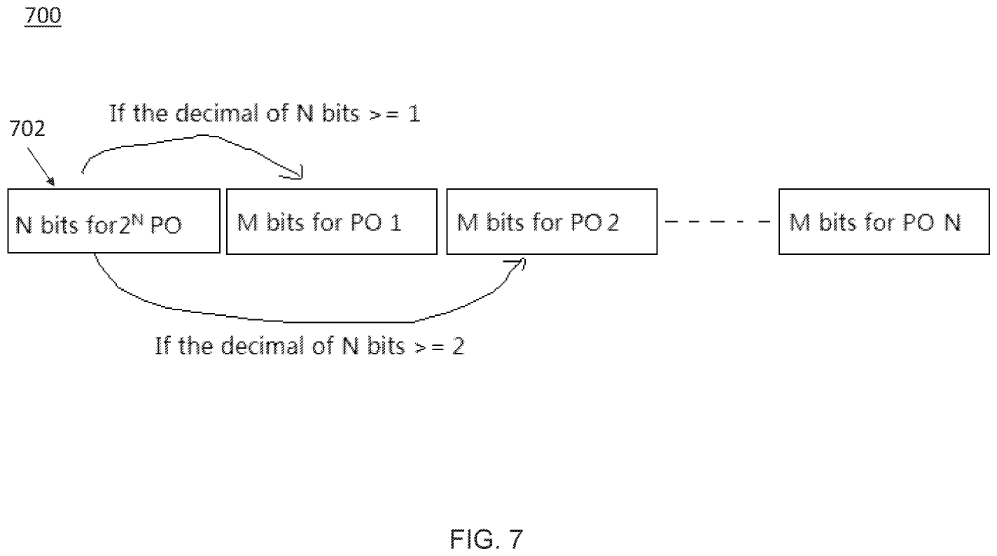

FIG. 7 shows an example bit field structure 700. Structure 700 can indicate 2^{N} POs with flexible N+M*2^{N} bits for group indication.

Similar to structure 600 depicted in FIG. 6, the first N bits for comprising block 702 are always present while the latter blocks of M bits might not present. Since there can be up to 2^{N} POs indicated, there can be up to 2^{N} M-bit blocks. A codepoint, such as a decimal value of bits, can indicate POs or groups. In some embodiments, if the decimal value of the first block 702 is greater than or equal to 1, then there can be a block of M bits corresponding to PO 1. If the decimal value of the first block 702 is greater than or equal to 2, then there can be another block of M bits corresponding to PO 2. This can continue for higher numbers up to 2^{N} POs.

In some embodiments, a decimal value the first block 702 can indicate zero POs. In some embodiments, a decimal value of first block 702 being zero can indicate all the POs. In some embodiments, a decimal value that is greater than some predetermined value (e.g., 2) will indicate all the POs.

The floating structure (or flexible structure) 700 can also be fixed. That is, no matter what the decimal value of bits in the first block 702 is, the following blocks are always present.

### Structure 4

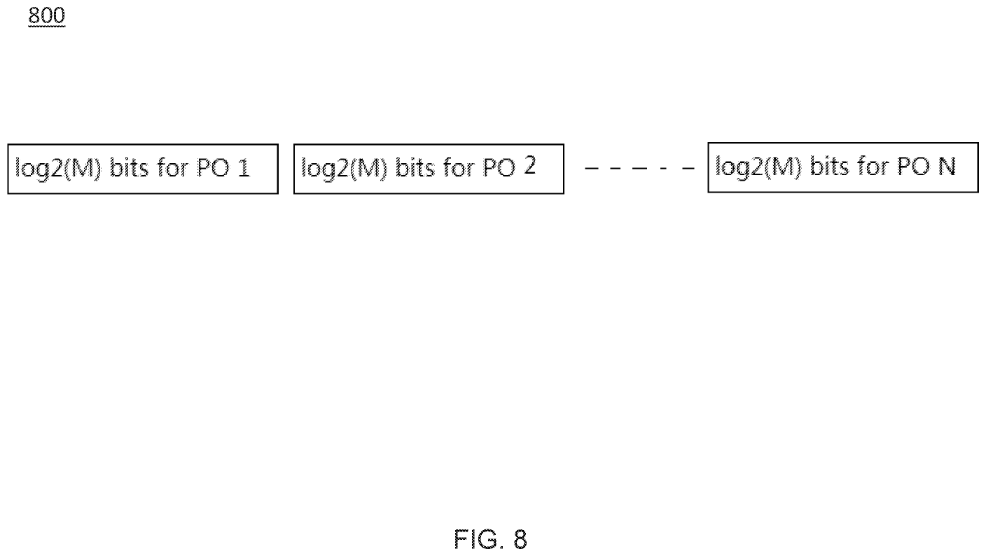

FIG. 8 shows an example bit field structure 800. Structure 800 can indicate N POs using N*log₂(M) bits for group indication.

Like structure 700 of FIG. 7, structure 800 uses a codepoint, such as a decimal value of the bits to indicate groups within a PO. In some embodiments, if the decimal value of bits is zero, none of groups (e.g., UE group or PO group) will be indicated. In some embodiments, if all the bits are “1”, then all the groups can be indicated. For other cases, a PO group can be addressed or indicated according to a codepoint as follows:

$$Codepoint = DecimalValueOfLog 2 MBit = \{ \begin{matrix}0 , & for none of group being addressed \\ 1 \sim ( {2}^{N} - 2 ) , & for {( Codepoint )}^{th} group being addressed \\ {2}^{N} - 1 , & for all groups being addressed\end{matrix}$$

For example, if there are M=8 PO groups, then the following table can be used to indicate PO groups using 3 bits for each PO.

| log2(8) = 3 | Codepoint (decimal | |
|---|---|---|
| bits | value of bits) | Indication |
| 000 | 0 | None of groups will be indicated. |
| 001 | 1 | The first group will be indicated. |
| 010 | 2 | The second group will be indicated. |
| 011 | 3 | The third group will be indicated. |
| 100 | 4 | The fourth group will be indicated. |
| 101 | 5 | The fifth group will be indicated. |
| 110 | 6 | The sixth group will be indicated. |
| 111 | 7 | All the groups will be indicated. |

Note that in this table, there is no entry corresponding to “the seventh group will be indicated.” In some embodiments, a table can be configured to include such an entry. Other combinations of indicating PO groups can be configured, as there can be more than 2^{N} PG group combinations that can be indicated.

With this structure only log₂(M) bits are used per group. The bit overhead can be reduced, improving base station coverage.

### Structure 5

In some embodiments, N POs can be indicated using M bits for group indication (i.e., M bits in total). This can be the case if all of the N POs have the same indication content. This can apply when these N POs are associated with one UE or UE identification (UE ID) or if these N POs are associated with a UE within a group or UE ID within a group. In some embodiments, an i-th bit of “1” represents that the i^{th} group is addressed or paged for all POs, where i=1, 2, . . . , M. This structure can be helpful for reduced capability (RedCap) UEs because a RedCap UE requires low cost, low complexity, or low power consumption. By using only M bits to indicate groups, this structure requires less data to be processed.

### Structure 6

In some embodiments, N bits can indicate N POs along with M bits for group indication (i.e., N+M bits in total). The first N bits can indicate which of N POs will be addressed. The next M bits can indicate the M PO groups for all of the POs addressed by the first N bits. That is, each of the addressed POs will indicate the same sequence of PO groups respectively. For example, if M=3, and the M bits read “101”, then the first and third groups will be indicated for each PO indicated by the first N bits.

### Structure 7

In some embodiments, N POs with M groups can be indicated with ceil(log₂(N))+M bits in total. With this method, one or multiple POs can be addressed. For example, if N=4, then the first ceil(log 2(N))=2 bits can indicate how many POs are addressed. This can be done using a decimal value of these bits and adding 1 to determine the number of POs that are addressed. For example, if these two bits are “01”, the the first two POs are addressed. Then the next M bits can indicate the PO groups for all the POs addressed, similar to structure 6 above.

The number of POs associated with one PEI/WUS can be conditioned on a configuration of parameters. In some embodiments, the number of POs associated with one PEI/WUS can be set as the number of paging occasions (PO) in a paging frame (PF). For example, if the number of POs in a PF is two, then the number of POs associated with one PEI/WUS can be set to two.

In some embodiments, the number of POs associated with one PEI/WUS can be associated with the number of total paging frames in a paging cycle. For example, if there are 8 total paging frames in a paging cycle, then the number of POs associated with one PEI/WUS can be set to that value (i.e., 8).

In some embodiments, the number of POs associated with one PEI/WUS can be associated with the total number of PFs in a paging cycle and the number of POs in a PF. For example, if there are 4 PFs in a paging cycle, and there are 4 POs in a PF, then the number of POs associated with one PEI/WUS can be their product (i.e., 4*4=16).

With this method, each PO and each UE group can be indicated effectively. Hence, the power consumption of UE can be saved (because the UE that is not indicated can go to sleep without receiving PO).

### Example 2

In addition to indicating a PO/group, a PEI/WUS can also indicate the availability of a CSI-RS resource or a tracking reference signal (TRS). In some implementation, to reduce resource overhead and assist UE power saving, the CSI-RS resource can be shared from a UE in an RRC_Connected mode.

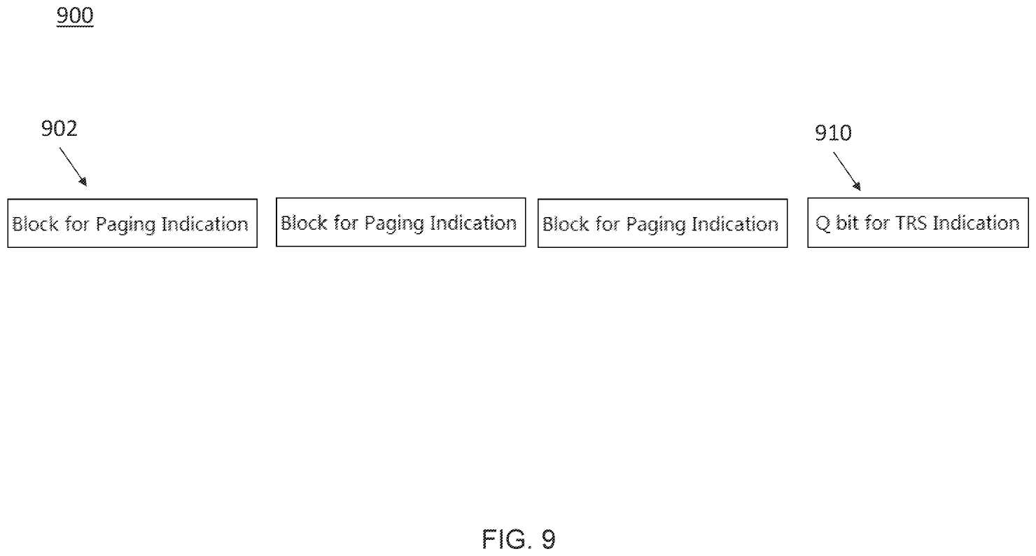

FIG. 9 shows an example bit field structure 900. If a PEI/WUS is based on PDCCH, structure 900 can be used to indicate CSI-RS resource availability. In structure 900, one or more Q bits 910 are placed after one or more blocks 902 for paging indication. Alternately, the Q bits 910 for CSI-RS indication can be placed before one or more blocks for paging indication.

With this structure, each bit in the Q bit(s) CSI-RS indication can separately indicate which set of CSI-RS is available or not. A bit “1” in the Q bit(s) CSI-RS indication can indicate that a corresponding set of CSI-RS is available. For example, if Q=4, and these Q bits are “1011”, then the first, third and fourth set of CSI-RS is available while the second set of CSI-RS is unavailable.

If more than Q sets of CSI-RS should be indicated, then a predefined operation can be applied. For example, if more than Q sets of CSI-RS should be indicated, then a modulo operation can applied. For example, a kth set of CSI-RS resources can be indicated by a qth bit of the Q bits, wherein q=1+mod((k−1, Q). For example, if Q=4, and there are 6 sets of CSI-RS (CSI-RS resources) to be indicated, then the first bit can indicate the availability of the first and fifth set of CSI-RS. The second bit can indicate the availability of the second and sixth set of CSI-RS. With this method, the bit width can be reduced.

In some embodiments, a codepoint of the Q bits 910 can indicate which set of CSI-RS resources is available. For example, if Q=2, then the following table can be applied.

| | Binary | |
|---|---|---|
| Codepoint (e.g., | format | |
| decimal of Q bit) | of Q bit | Indication |
| 0 | 00 | The first set of resource is available. |
| 1 | 01 | The second set of resource is available. |
| 2 | 10 | The third set of resource is available. |
| 3 | 11 | All the sets of resource are available. |

Note that other tables can be applied for different numbers/combinations of CSI-RS resources besides those shown in the table.

In some embodiments, the availability of CSI-RS resources can be indicated with a specific pattern of the blocks for paging indication. For example, if all the blocks for paging indication are all bit “0”, then all the CSI-RS resources can be unavailable. If all the block(s) for paging indication are all bit “1”, then all the CSI-RS resources can be available. With this method, no additional overhead is needed for indication of the availability of the CSI-RS resources. Hence, the coverage of PEI/WUS can be improved.

In some embodiments, if there is no CSI-RS resource configured or broadcast, there are no Q bits 910 in the PEI/WUS. In some embodiments, if there is no CSI-RS resource configured, then these Q bits 910 are present but reserved. In some embodiments, if there is no CSI-RS resource configured, then the Q bits 910 are set with some default value (e.g., all “0”).

If the PEI/WUS is based on reference signal, such as CSI-RS, secondary synchronization signal (SSS), or demodulation reference signal (DM-RS), then the availability of the CSI-RS resources can be indicated via sequence generation. In some embodiments, different initial seeds can indicate which set of CSI-RS resources are available. For example, an initial seed of [1, 1, 0, 0, 0, 0, 0] in the first initial seed (e.g., x₀) can indicate the first and second set of CSI-RS resources are available while the others are unavailable. A second initial seed (e.g., x₁, with seven bits or 31 bits) can also indicate the availability of CSI-RS resource.

In some embodiments, both PEI/WUS and paging-PDCCH can carry bits for indication of CSI-RS availability. In some embodiments, if an indicated CSI-RS occasion's availability conflicts with an occasion of PEI/WUS, then the indicated CSI-RS occasion can be invalid (e.g., unavailable or absent). Alternatively, if the indicated CSI-RS occasion's availability conflicts with an occasion of PEI/WUS, then the indicated CSI-RS resource can be invalid. If an indicated CSI-RS occasion overlaps with a PDSCH carrying system information, then the indicated CSI-RS occasion can be invalid. If an indicated CSI-RS occasion overlaps with SSB or an SSB burst, then the indicated CSI-RS occasion can be invalid.

In some embodiments, a maximum T=4 CSI-RS resources or occasions can be indicated by a PEI/WUS (i.e., Q<4). In some embodiments, a maximum T=8 CSI-RS resources can be indicated by PEI/WUS (i.e., Q<8). These CSI-RS resources can be periodic. If the number of CSI-RS resources indicated is greater than T, then PEI/WUS may only indicate T CSI-RS resources.

In some embodiments, a maximum V periodic CSI-RS resources can be indicated by PEI/WUS where V is the number of SSB indexes. For example, V=8 for frequency range 1 (FR1), and V=64 for frequency range 2 (FR2). If the number of CSI-RS resources indicated is greater than V, then they can be indicated in turn (e.g., first indication for first V CSI-RS resources, then other V CSI-RS resources).

In some embodiments, if the number of CSI-RS resources to be indicated (e.g., by PEI/WUS or, paging-PDCCH) is less than or equal to some value (e.g., V=8), then all the CSI-RS resources can be indicated, for example via a bitmap which can have V=8 bits. If the number of CSI-RS resources to be indicated is greater than or equal to the value, then all the CSI-RS resources can be indicated, such as via a codepoint which can have identical entries of V=8 bits, i.e., 2^{A}V=256 entries. Of the 256 entries, W=64 can be configured as valid entries while the other entries are reserved.

With this method, after receiving PEI/WUS and/or the paging-PDCCH of a PO, a UE in a RRC_Idle or RRC_Inactive state can know whether a CSI-RS occasion or resource is available or unavailable. With this knowledge, a UE in an RRC_Idle or RRC_Inactive state can receive the shared CSI-RS but not wait to receive an SSB at a later time. Hence, a UE in an RRC_Idle or RRC_Inactive state has more time to sleep, which reduces power consumption.

### Example 3

A control resource set (CORESET) of 5G-NR, in the frequency domain, is configured with W=6 physical resource blocks (PRBs), and a resource element group (REG) is a PRB within a symbol. For example, if the time domain duration of a CORESET is one symbol, then there are AL*6 PRBs in a control channel element (CCE), where AL is an aggregation level (e.g., 1, 2, 4, 8, 16).

The CCE to REG mapping can be interleaved or non-interleaved. But for CORESET zero (CORESET 0), it is interleaved.

If a PEI/WUS were based on SSS, then the length of the PEI/WUS sequence can be 127 resource elements (REs). A PRB has 12 subcarriers (SC), or 12 REs in one symbol. Thus, the PEI/WUS will occupy ceil(127/12)=11 PRBs and 2 CCEs. If the SSS-based PEI/WUS has a length of 127×2=254 REs (or 255 RE), then it will occupy 4 CCEs.

In some embodiments, the PEI/WUS or RE may be padded, such as with zeroes, if the length of PEI/WUS is not an exact multiple of the number of REs in the occupied CCEs. For example, if the length of the PEI/WUS sequence were L-127 RE, and it occupies N=2 CCEs, then the floor((N*W*SC−L)/2)=8 RE with lowest RE index can be filled with zeroes, i.e., padding. Alternatively, if the length of the PEI/WUS sequence were L=127 RE and it occupied N=2 CCE, then the ceil ((N*W*SC−L)/2)=9 RE with highest RE index can be filled with zeroes. Alternatively, if the length of the PEI/WUS sequence were L=127 RE and it occupied N=2 CCE, then the ceil ((N*W*SC−L)/2)=9 RE with highest RE index in the CCE with highest CCE index can be filled with zeroes. Alternatively, if the length of SSS-based PEI/WUS is not a multiple of the number of REs of one or more CCEs, zero padding can be applied to the two ends of the SSS-based PEI/WUS. For example, zero padding can applied to two ends of SSS-based PEI/WUS until the length of the PEI/WUS matches the number of REs of one or more CCEs. Alternatively, if the length of SSS-based PEI/WUS is not a multiple of the number of REs of one or more CCEs, zero padding can be applied to the two ends of the REs of CCEs allocated to the SSS-based PEI/WUS.

The SSS-based PEI/WUS can occupy a CORESET resource in an interleaved way. For example, the SSS-based PEI/WUS can occupy a CORESET zero resource as follows:

Step 1: Generate a sequence d_{PEI}(n) for SSS-based PEI/WUS as follows:

$${d}_{P E I} ( n ) = [ 1 - 2 {x}_{0} ( ( n + {m}_{0} ) mod 127 ) ] [ 1 - 2 {x}_{1} ( ( n + {m}_{1} ) mod 127 ) ] \cdot Cover ( n )$$

$${m}_{0} = 15 ⌊ \frac{{N}_{I D}^{( 1 )}}{112} ⌋ + 5 {N}_{I D}^{( 2 )}$$

$${m}_{1} = {N}_{I D}^{( 1 )} mod 112$$

$$0 \leq n < 127$$

Where N_{ID}⁽¹⁾ and N_{ID}⁽²⁾ can be based on cell ID or configured by a higher layer.

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

The initial seeds can be:

$$[ \begin{matrix}{x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 )\end{matrix} ] = [ \begin{matrix}0 & 0 & 0 & 0 & 0 & 0 & 1\end{matrix} ]$$

$$[ \begin{matrix}{x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 )\end{matrix} ] = [ \begin{matrix}0 & 0 & 0 & 0 & 0 & 0 & 1\end{matrix} ]$$

Cover(n) is a cover sequence, such as the (1+mod(Cell_ID, H))^{th} Walsh code with length K=128 and binary+1 and −1 as its elements, Cell_ID=3N_{ID}⁽¹⁾+N_{ID}⁽²⁾, and H=127. With the cover sequence, a false detection of another cell's SSS can be avoided.

In addition, the length of a SSS-based PEI/WUS can be changed to other value, such as 144 or 132. If the length is 0<n<144 or 0<n<132, the length can be changed to match the number of REs in 2 CCEs. This allows all REs within 2 CCE can be fully utilized. This length can also be adjusted for different numbers of CCEs, such as 4.

Step 2: Generate a interleaved PRB pattern according to the following sub-steps.

Step 2-1: Generate an REG bundle index for every W=6 REG. A REG can be numbered by time first, then by RB index starting from lowest RB index. The REG bundle index can be numbered from 0 to N^{RB}*N^{Sym}/W−1 where N^{RB} is the number of RBs allocated to the CORESET and, N^{Sym} is the number of symbols in the time domain allocated to the CORESET.

Step 2-2: Write the REG bundle index into an R*C rectangle interleaver, where R=2 rows and C=(N^{RB}*N^{Sym}/W)/R columns, writing by column starting from the first row.

Step 2-3: Read out the CCE index from the R*C rectangle interleaver row by row starting from first column.

For example, for a CORESET can have 24 RB and one symbol duration, CCE #0 can have RB{0,1,2,3,4,5}, CCE #1 can have RB{12,13,14,15,16,17}, CCE #2 can have RB{6,7,8,9,10,11}, and CCE #3 can have RB{18,19,20,21,22,23} as shown in the following table. When an SSS-based PEI/WUS is transmitted, it can be mapped on CCE #0 and CCE #1. That is, RB{0,1,2,3,4,5, 12,13,14,15,16,17} can be used for this SSS-based PEI/VWUS. Alternatively, this SSS-based PEI/WUS can be mapped on CCE 2 and CCE 3, corresponding to RB{6,7,8,9,10,11, 18,19,20,21,22,23}. In some embodiments, an SSS-based PEI/WUS can be transmitted repeatedly from CCE 0 and CCE 1 to CCE 2 and CCE 3.

In addition, Step 1 as described above can be performed after Step 2.

| CCE Index | RB Index | REG Index | REG Bundle Index |
|---|---|---|---|
| CCE 3 | RB 18-23 | REG 18-23 | 3 |
| CCE 1 | RB 12-17 | REG 12-17 | 2 |
| CCE 2 | RB 6-11 | REG 6-11 | 1 |
| CCE 0 | RB 0-5 | REG 0-5 | 0 |

For a CORESET that has 24 RBs and two symbols duration, the CCL to RB mapping can be illustrated as in the following table. If one SSS-based PEI/WUS is transmitted, it can be mapped on CCE 0 and CCE 1, so RB{0,1,2,6,7,8} can be used for this SSS-based PEI/WUS. If one SSS-based PEI/WUS would occupy 4 CCEs, then CCL 0-3 or CCEs 4-7 can be used.

| | RB | REG Index | | REG Bundle |
|---|---|---|---|---|
| CCE Index | Index | In first symbol | In second symbol | Index |
| CCE 7 | 23 | 46 | 47 | 7 |
| | 22 | 44 | 45 | |
| | 21 | 42 | 43 | |
| CCE 3 | 20 | 40 | 41 | 6 |
| | 19 | 38 | 39 | |
| | 18 | 36 | 37 | |
| CCE 6 | 17 | 34 | 35 | 5 |
| | 16 | 32 | 33 | |
| | 15 | 30 | 31 | |
| CCE 2 | 14 | 28 | 29 | 4 |
| | 13 | 26 | 27 | |
| | 12 | 24 | 25 | |
| CCE 5 | 11 | 22 | 23 | 3 |
| | 10 | 20 | 21 | |
| | 9 | 18 | 19 | |
| CCE 1 | 8 | 16 | 17 | 2 |
| | 7 | 14 | 15 | |
| | 6 | 12 | 13 | |
| CCE 4 | 5 | 10 | 11 | 1 |
| | 4 | 8 | 9 | |
| | 3 | 6 | 7 | |
| CCE 0 | 2 | 4 | 5 | 0 |
| | 1 | 2 | 3 | |
| | 0 | 0 | 1 | |

For a CORESET that has 24 RBs and three symbols duration, the CCE to RB mapping can be illustrated as in the following table. If one SSS-based PEI/WUS is transmitted, it can be mapped onto CCE 0 and CCE 1, i.e., CCL 0 and 1 can be allocated. A UL can perform blind detection on these target CCLs. With this mapping, RB{0,1,4,5} can be used for this SSS-based PEI/WUS.

| | | | | | REG |
|---|---|---|---|---|---|
| CCE | RB | REG Index | | | Bundle |
| Index | Index | First symbol | Second symbol | Third symbol | Index |
| 11 | 23 | 69 | 70 | 71 | 11 |
| | 22 | 66 | 67 | 68 | |
| 5 | 21 | 63 | 64 | 65 | 10 |
| | 20 | 60 | 61 | 62 | |
| 10 | 19 | 57 | 58 | 59 | 9 |
| | 18 | 54 | 55 | 56 | |
| 4 | 17 | 51 | 52 | 53 | 8 |
| | 16 | 48 | 49 | 50 | |
| 9 | 15 | 45 | 46 | 47 | 7 |
| | 14 | 42 | 43 | 44 | |
| 3 | 13 | 39 | 40 | 41 | 6 |
| | 12 | 36 | 37 | 38 | |
| 8 | 11 | 33 | 34 | 35 | 5 |
| | 10 | 30 | 31 | 32 | |
| 2 | 9 | 27 | 28 | 29 | 4 |
| | 8 | 24 | 25 | 26 | |
| 7 | 7 | 21 | 22 | 23 | 3 |
| | 6 | 18 | 19 | 20 | |
| 1 | 5 | 15 | 16 | 17 | 2 |
| | 4 | 12 | 13 | 14 | |
| 6 | 3 | 9 | 10 | 11 | 1 |
| | 2 | 6 | 7 | 8 | |
| 0 | 1 | 3 | 4 | 5 | 0 |
| | 0 | 0 | 1 | 2 | |

Step 3: Map the sequence onto the RE according to the interleaving pattern. In some embodiments, the sequence can be mapped according to REG index. The sequence can be mapped first in the frequency domain, then in the time domain, for both the allocated CCE or for the target CCE. This mapping can apply for a target CCL for UL blind detection, a CCE to be decoded, or a CCL for UL detection.

In some embodiments, the frequency domain first mapping can be applied to a candidate number of CCEs of the CCL to be decoded, such as 4 CCEs. For example for four CCEs with two symbols and an SSS-based PEI/WUS of length 127 RE of, the first PEI/WUS can be mapped on the first symbol while the second PEI/WUS can mapped on the second symbol. In some embodiments, the sequence can be mapped first in the frequency domain, then repeated in time domain. In some embodiments, the sequence can be mapped according to RB index first of the RB allocated to it, then REG index. In some embodiments, the sequence can be mapped according to RB index first of the RB allocated to it, then according to time second). For example, for a CORESET with 24 RBs and two symbols duration, if CCL 0 and 1 were allocated to one PEI/WUS, then the sequence of this PEI/WUS can be mapped as {RB 0 in the first symbol, RB 1 in the first symbol, RB 2 in the first symbol, RB 6 in the first symbol, RB 7 in the first symbol, RB 8 in the first symbol, RB 0 in the second symbol, RB 1 in the second symbol, RB 2 in the second symbol, RB 6 in the second symbol, RB 7 in the second symbol, RB 8 in the second symbol}. On a REG index basis, the mapping corresponds to {REG 0, REG 2, REG 4, REG 12, REG 14, REG 16, REG 1, REG 3, REG 5, REG 13, REG 15, REG 17}.

If a CORESET (e.g., CORESET Zero) is configured with more than one symbol (e.g., two symbols), then one SSS-based PEI/WUS can occupy REs on one symbol. Similarly, if a CORESET (e.g., CORESET Zero) is configured with more than one symbol (e.g., two symbols), then one SSS-based PEI/WUS can occupy REGs on one symbol. For example, if a CORESET Zero has two symbols, then one SSS-based PEI/WUS with length 127 can occupy {REG 0, REG 2, REG 4, REG 12, REG 14, REG 16, REG 24, REG 26, REG 28, REG 36, REG 38, REG 40}, which are the REGs on the first symbol of this CORESET. By processing only one symbol, the UE can reduce power consumption.

In some embodiments, if a CORESET (e.g., CORESET Zero) can be configured with more three symbols, and an SSS-based PEI/WUS can occupy REGs or REs on one symbol. In some embodiments, if a CORESET (e.g., CORESET Zero) is configured with more than one symbol (e.g., two symbols or more), then one SSS-based PEI/WUS can occupy REGs or REs on one symbol and repeat itself on other symbols. For example, if a CORESET Zero has two symbols, an SSS-based PEI/WUS with length 127 can occupy REG{0, 2, 4, 12, 14, 16, 24, 26, 28, 36, 38, 40} and repeat itself on REG{1, 3, 5, 13, 15, 17, 25, 27, 29, 37, 39, 41}. Thus, a UE can receive these two symbols separately and combine them together to improve performance. In addition, the REG{1, 3, 5, 13, 15, 17, 25, 27, 29, 37, 39, 41} can be allocated to another SSS-based PEI/WUS or other type of PEI/WUS a CSI-RS-based PEI/WUS.

Similarly, the mapping rules above can also be applied for a CSI-RS-based PEI/WUS. The mapping rule can be applied for a CSI-RS-based PEI/WUS with a multiple of 144 REs in length. Alternately, the mapping rule can also be applied for a CSI-RS-based PEI/WUS with a multiple of 72 REs in length. In some embodiments, the sequence r(m) for a CSI-RS-based PEI/WUS is:

$$r ( m ) = ( \frac{1}{\sqrt{2}} ( 1 - 2 \cdot c ( 2 m ) ) + j \frac{1}{\sqrt{2}} ( 1 - 2 \cdot c ( 2 m + 1 ) ) ) \cdot Hadamard ( m )$$

where the pseudo-random sequence c(i) is defined as follows: the pseudo-random sequence generator can be initialized with

$${c}_{i n i t} = ( {2}^{10} ( {N}_{s y m b}^{slot} {n}_{s , f}^{μ} + l + 1 ) ( 2 {n}_{I D} + 1 ) + {n}_{I D} ) mod {2}^{31}$$

at the start of each orthogonal frequency division multiplexing (OFDM) symbol where n_{s,f}^{μ} is the slot number within a radio frame, l is the OFDM symbol number within a slot, and n_{ID} is configured by higher layer. Hadamard(m) is a Hadamard sequence (e.g., the (1+mod(Cell_ID*PO_Index, H))^{th} Hadamard codes with length J=256 (or J=128 or J=512) with binary+1 and −1 as its elements, H=72, 144, or 288). Cell_ID=3N_{ID}⁽¹⁾+N_{ID}⁽²⁾ is cell ID. The PO_Index=1, . . . , Number_of_PO_Configured. Wherein, the Number_of_PO_Configured is the number of PO Configured from {1,2,4} by a higher layer.

In some embodiments, the Hadamard sequence above can be replaced with a Walsh sequence, such as illustrated above. For example, the Hadamard sequence can be replaced with the Walsh sequence with binary+1 and −1, as illustrated above.

The pseudo-random sequences can be defined by a length-31 Gold sequence. The output sequence c(n) of length M_{PN}, where n=0,1. M_{PN}−1, is

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

where N_{C}=1600 and the first m-sequence x₁(n) can be initialized with x₁(0)=1, x₁(n)=0, n=1, 2, . . . , 30. The initialization of the second m-sequence, x₂(n), is denoted by

$${c}_{i n i t} = {\sum }_{i = 0}^{30} {x}_{2} ( i ) \cdot {2}^{i}$$

with the value depending on the application of the sequence.

A CSI-RS-based PEI/WUS can be mapped on a DM-RS associated with PDCCH, such as on a DM-RS location. A CSI-RS-based PEI/WUS can be mapped on the DM-RS associated with PDCCH on CORESET zero. A CSI-RS-based PEI/WUS can be mapped on one or multiple symbols of DM-RS for PDCCH. Similarly, an SSS-based PEI/WUS can also be mapped on a DM-RS associated with PDCCH.

When a UE is detecting a PEI/WUS, such as PDCCH-based PEI/WUS, it can search the PEI/WUS on the CCE of a search space. In some embodiments, when the search space for random access response (RAR), message 2 (Msg2), message B (MsgB), or beam recovery collides with a search space for PEI/WUS, the PEI/WUS is dropped. In some embodiments, a UE is not configured to expect a collision between a search space for PEI/WUS and a search space for RAR, Msg2, MsgB, or beam recovery, such as a CCE collision or collision on the same CCE.

A PEI/WUS, such as a PDCCH-based PEI/WUS, can have one or multiple monitoring occasions. The PEI/WUS can have a time window (e.g., 10 slots) for transmission. A UE can be configured to monitor a PEI/WUS within a time window. In some embodiments, a UE is not configured to expect a PEI/WUS outside of a time window. With this limitation, the power consumption of UE can be saved.

In some embodiments, if a sequence-based PEI/WUS (e.g., SSS-based PEI/WUS or CSI-RS-based PEI/WUS) is mapped onto a CORESET (e.g., CORESET zero) or search space, then no DM-RS on the CCE (or REG, RE, RB, or symbol) is allocated to the sequence based PEI/WUS. For example, a DM-RS on the CCE (or REG, RE, RB, or symbol) allocated to the sequence-based PEI/WUS can be overridden by the sequence-based PEI/WUS.

In some embodiments, an indicated CSI-RS occasion can be invalid if it overlaps with a CORESET. For example, if the indicated CSI-RS occasion(s) by PEI/WUS overlaps with a CORESET scheduling paging message, then the indicated CSI-RS occasion will be invalid. In another example, an indicated CSI-RS occasion that overlaps with a CORESET zero will be invalid. In another example, an indicated CSI-RS occasion that overlaps with a CORESET zero that schedules paging message will be invalid. In yet another example, an indicated CSI-RS occasion that overlaps with a CORESET, including CORESET zero, that transmits PEI/WUS will be invalid.

With this method, one SSS-based PEI/WUS can co-exist with PDCCH on CORESET 0 without mutual interference. If the resource of CORESET 0 is not occupied by PDCCH, then the available resource can be provided for an SSS-based PEI/WUS.

### Example 4

For a UE in an RRC_Connected state, a BS can configure CSI-RS or TRS resources for it via dedicated signaling. The dedicated signaling can be very large in size. Because the signaling includes many parameters, such as those in the following table, the signaling overhead is high. It should be noted that this table is only for one set of CSI-RS resources, and a UE may have several sets of CSI-RS resources.

| Parameters | Applicable values |
|---|---|
| powerControlOffsetSS/dB | {−3, 0, 3, 6} |
| scramblingID | 0 to 1023 |
| firstOFDMSymbolInTimeDomain | 0 to 9 |
| startingRB | 0 to 274 |
| nrofRBs | 24 to 276 |
| . . . | . . . |

When a CSI-RS or TRS is shared for a UE in an RRC_Idle or RRC_Inactive state, such as for SYNC/AGC, the configuration information of the shared CSI-RS or TRS can be broadcasted in system information block (SIB). However, if all these parameters were broadcasted in SIB, the signaling overhead will be high. As the result, a default value can be applied if a parameter is not configured, as shown in the following table.

| | | Default value if not |
|---|---|---|
| Parameters | Applicable values | configured |
| powerControlOff- | {−3, 0, 3, 6} | 0 |
| setSS/dB | | |
| scramblingID | 0 to 1023 | 0 or Cell ID |
| firstOFDMSym- | 0 to 9 | 6 |
| bolInTimeDomain | | |
| startingRB | 0 to 274 | Identical to that of |
| | | CORESET 0 or initial |
| | | downlink (DL) |
| | | bandwidth part (BWP) |
| nrofRBs | INTEGER | Identical to that of |
| | (24 . . . maxNrofPhysi- | CORESET 0 or initial |
| | calResourceBlocksPlus1) | DL BWP |
| . . . | . . . | . . . |

In addition, an SIB has a maximum length (e.g., X=1728 bits). Hence, if the SIB for broadcasting configuration information of a shared CSI-RS resource must be larger than X bits, a default value can applied. For example, all CSI-RS parameters can be set as a default value. In some embodiments, a CSI-RS resource will not be shared for a UE under RRC_Idle or RRC_Inactive state if the SIB exceeds the maximum length. In some embodiments, a UE is not configured to expect an SIB that carries configuration information of a shared CSI-RS resource with a length larger than X bits.

Alternatively, if the size of SIB for broadcasting the configuration information of the shared CSI-RS resource is larger than X bits, then it will be segmented into several parts with equal size.

In some embodiments, two or more fields including configuration information of a shared CSI-RS resource can be combined to reduce signaling overhead. Also, two or more fields of the configuration information of the shared CSI-RS resource can be jointly indicated to reduce signaling overhead. For example, the field “startingRB” can have ceil(log 2(274))=9 bits, the field “nrofRBs” can also have ceil(log 2(274))=9 bits. These two fields thus comprise 18 bits. If they were combined together, such as using a resource indicator value (RIV), they can comprise ceil(log 2(274*(274+1)/2))=16 bits in combination, thus saving bits and reducing signaling overhead for sharing the CSI-RS resource.

### Example 5

For a UE in an RRC_Idle/RRC_Inactive state, the only reference signal is SSB. Hence, there is no CSI-RS for it. For a UE in an RRC_Connected state, one or more CSI-RS resources or resource sets can be configured. These CSI-RS resources can be shared for a UE in an RRC_Idle/RRC_Inactive state, such as via broadcast over SIB.

For each CSI-RS resource, Quasi-Co-Location (QCL) information (e.g., beam direction) can be included in the following data field. The QCL information can include QCL type and index to SSB.

| | |
|---|---|
| NZP-CSI-RS-Resource ::= | SEQUENCE { |

...

| | | |
|---|---|---|
| qcl-InfoPeriodicCSI-RS | TCI-StateId | OPTIONAL, -- Cond Periodic |

...
}

For a high frequency band (e.g., FR2), there can be many CSI-RS resources being configured (e.g., 64 resources or more). If the QCL information of each CSI-RS resource are broadcasted, then there will be a lot of signaling overhead. Hence, methods are needed to reduce the signaling overhead.

In some embodiments, if the number of configured CSI-RS resources is less than or equal to some value (e.g., four resources, or, four resources set), then QCL information of each CSI-RS resource can be indicated or broadcast separately. The QCL type can be fixed in protocol (e.g., QCL type C, or QCL type D), or to reduce signaling overhead, the QCL type can be omitted. The QCL index to SSB can be indicated in PEI/WUS and/or paging-PDCCH.

If the number of configured CSI-RS resources is larger than some value (e.g., eight resources, or, eight resources set), then these CSI-RS resources are divided into several groups and the group related information (e.g., which CSI-RS resource or CSI-RS resource set belongs to a group) are broadcasted. Alternatively, each QCL information of each group are indicated.

Alternatively, if the number of shared RS resource (set) is small (e.g., just two RS resources), then the shared RS resource (set) can be indicated directly. For example, the first shared RS resource is associated with SSB index 0 and the second shared RS resource is associated with SSB index 1.

If there are many shared CSI-RS or TRS resources, to reduce signaling overhead, the resource ID can be divided into several groups according to some feature, such as SSB index. For example, if there are X=6 SSB indices and each has Y=4 shared RS resources then there are 24 total shared RS. Grouping the RS resources by SSB index can be used to indicate the QCL information of these 24 RS resources using 6 indices.

If many CSI-RS resources are configured with almost the same parameters, the signaling overhead will still be high. To reduce signaling overhead, the identical parameters can be expressed only once. In other words, common parameters can be configured once for all the CSI-RS resources so other CSI-RS resources do not individually configure the parameters. Also, a default value can be applied to the common parameters if not configured. With this method, the signaling overhead for broadcasting the QCL information of CSI-RS resources can be reduced.

### Example 6

To improve the performance of PEI/WUS, a PEI/WUS may carry a few bits (e.g., K=3 bits). But the states to be addressed might be too large for the number of bits (e.g., 255 combinations). Hence, methods are needed to represent additional combinations with small numbers of bits. An example is in the following table. Note that the table uses 3 bits, but similar tables may be configured for different numbers of bits and/or groups.

| Entry | Bits | Operation |
|---|---|---|
| 0. | 000 | None group is addressed. |
| 1. | 001 | The first group is addressed. |
| 2. | 010 | The second group is addressed. |
| 3. | 011 | The third group is addressed. |
| 4. | 100 | The fourth group is addressed. |
| 5. | 101 | The 1^{st}, 2^{nd}, 3^{rd} and 4^{th} group are |
| | | addressed or, |
| | | any two groups are addressed. |
| 6. | 110 | The 5^{th}, 6^{th}, 7^{th} and 8^{th} group are |
| | | addressed or, |
| | | any three groups are addressed. |
| 7. | 111 | Addressing all groups |

First, a higher layer can configure one or more tables to be used to indicate which operation will be apply. The higher layer configuration information can include whether the said paging indication channel indicates directly (e.g., applying the bit structure in the example above). The higher layer configuration information can also include a configuration table, configuration entity, or configuration instance, configuration set, or mapping relationship with multiple entries, such as the table above. For example, the higher layer configuration information can include a configuration entity with multiple values and its corresponding operation (e.g., value 0 for operation 1, value 1 for operation 2, value 2 for operation 3). For example, the table above is used. Other parameters can be jointly applied with this table.

The table can be used to indicate a paging probability for a group. For example, the first group can have the highest paging probability, followed by the second group, the third group, etc. With this method, a group with relatively high paging probability can be addressed directly. For example, a group with relatively high paging probability can be addressed in an independent entry separate from entries associated with other groups.

Second, a PEI/WUS can indicate which entry is addressed. For example, if entry 4 is addressed in the above table, then the fourth group is paged.

A base station can indicate a table as follows. An SIB can indicate which table is applied if there are multiple tables configured. If a table is not indicated, then a default table can be applied. Alternatively, if there is no table configured, then a default operation (e.g., “Addressing all groups”) can applied.

Different tables can be applied according to different conditions or UEs, such as different UE categories/device types. For example, for a RedCap UE, the first table can applied while the below table can applied for a non-RedCap UE.

| Entry | Bits | Operation |
|---|---|---|
| 0. | 000 | None group is addressed. |
| 1. | 001 | The first group is addressed. |
| 2. | 010 | The second group is addressed. |
| 3. | 011 | The third group is addressed. |
| 4. | 100 | The 1^{st} and 2^{nd} group are addressed. |
| 5. | 101 | The 3^{rd} and 4^{th} group are addressed. |
| 6. | 110 | The 5^{th}, 6^{th}, 7^{th} and 8^{th} group are |
| | | addressed. |
| 7. | 111 | Addressing all groups |

Similarly, CSI-RS availability indication can also utilize the method above. Also, paging groups and CSI-RS resource availability can be jointly indicated as in the following table:

| Entry | Bits | Operation |
|---|---|---|
| 0. | 000 | None group is addressed. |
| | | There is no CSI-RS (i.e., all are unavailable). |
| 1. | 001 | The first group is addressed. |
| | | The first CSI-RS resource is available. |
| 2. | 010 | The second group is addressed. |
| | | The second CSI-RS resource is available. |
| 3. | 011 | The third group is addressed. |
| | | The third CSI-RS resource is available. |
| 4. | 100 | The 1^{st} and 2^{nd} group are addressed. |
| | | The first CSI-RS resource is unavailable. |
| 5. | 101 | The 3^{rd} and 4^{th} group are addressed. |
| | | The second CSI-RS resource is unavailable. |
| 6. | 110 | The 5^{th}, 6^{th}, 7^{th} and 8^{th} group are addressed. |
| | | The third CSI-RS resource is unavailable. |
| 7. | 111 | Addressing all groups |
| | | All the CSI-RS resources are available |

A configuration table can be adaptively extended as the following table where “N/A” means “not available.” With this configuration table, different numbers of entries can be supported. For example, at one time, when 8 paging groups are configured, then the column with “8 Entry” can be applied. At another time, when 4 paging groups are configured, then the column with “4 Entry” can applied. That is, a small table can be embedded in a big table. Alternatively, a configuration entity that supports a variable number of entries can be used.

| Entry | | | Bits | | | |
|---|---|---|---|---|---|---|
| 8 Entry | 4 Entry | 2 Entry | 8 Entry | 4 Entry | 2 Entry | Operation |
| 0. | 0 | 0 | 000 | 00 | 0 | None group is addressed. |
| 1. | 1 | N/A | 001 | 01 | N/A | The first group is addressed. |
| 2. | 2 | N/A | 010 | 10 | N/A | The second group is addressed. |
| 3. | N/A | N/A | 011 | N/A | N/A | The third group is addressed. |
| 4. | N/A | N/A | 100 | N/A | N/A | The fourth group is addressed. |
| 5. | N/A | N/A | 101 | N/A | N/A | The 1^{st}, 2^{nd}, 3^{rd} and 4^{th} group are |
| | | | | | | addressed or, |
| | | | | | | any two groups are addressed. |
| 6. | N/A | N/A | 110 | N/A | N/A | The 5^{th}, 6^{th}, 7^{th} and 8^{th} group are |
| | | | | | | addressed or, |
| | | | | | | any three groups are addressed. |
| 7. | 3 | 1 | 111 | 11 | 1 | Addressing all groups |

With this method, with few bits, the most important several combinations can be indicated. It should be noted that in many cases, there may be no need to indicate all combinations of groups.

### Example 7

In a paging-PDCCH, there are several “Reserved bits” (6 bits or more). These “Reserved bits” can be used to indicate a paging group, such as a UE group, and/or a CSI-RS resource availability. Note that when discussing indication of groups/paging groups, the same principles can apply to indicate CSI-RS resource availability.

First, a higher layer (e.g., via SIB) can configure how many bits of the “Reserved bits” are used for paging group indication and/or CSI-RS resource availability indication. For example, three bits can be used for paging group indication. Two, four, five, and so on could also be used.

Second, a meaning of the “Reserved bits” is determined. If the number of bits required is less than or equal to the number of the “Reserved bits”, then the first several bits (or the last several bits) can be used for indication while the other bits are still be reserved. Indications include paging indications and/or CSI-RS or TRS resource availability indications. For example, if there are four paging groups, then two bits can be used for paging indication. If the first two bits of the “Reserved bits” are used for paging group indication, then the remaining reserved bits can be kept as “Reserved bits.” Alternatively, the remaining reserved bits can be set as known value (e.g., all 0).

In some embodiments, it may be desired to use the reserved bits to address different combinations of groups.

| Entry | Bits | Operation |
|---|---|---|
| 0. | 00 | None group is addressed. |
| 1. | 01 | The first group is addressed. |
| 2. | 10 | The first and second group is addressed. |
| 3. | 11 | Addressing all groups |

If the number of bits required is larger than the number of the “Reserved bits”, then each of the “Reserved bits” can represent one group, while all the “Reserved bits” being all “1” represents all groups are addressed. For example, the above table can be applied when there are two reserved bits for paging indication, but there are more than two groups.

A higher layer or SIB can indicate how many paging groups are configured. A higher layer or SIB can also indicate how many “Reserved bits” will be used.

In addition, multiple tables can be configured. A SIB can indicate which table is applied. If the SIB indication is absent, then the first table can be applied by default.

If all the “Reserved bits” are utilized, then a mapping table can still be used. For example, if three bits are used for paging group indication and another three bits are used for CSI-RS resource availability indication, then a table with 8 entries for paging group indication and another table with 8 entries for CSI-RS resource availability indication can be used.

These methods use a small number of bits to indicate paging groups that could otherwise require many more bits by indicating a selection of the most important combinations. It should be noted that, there is often no need to indicate all combinations. In this way, the “Reserved bits” can be effectively utilized for paging and CSI-RS indication even though it is a small number of bits.

### Example 8

Some UEs may support PEI/WUS, while some UEs will not support PEI/WUS. However, most UEs are configured to support paging-PDCCH. As the result, distributing configuration information including paging group indication and CSI-RS resource availability indication between PEI/WUS and PDCCH can allow for indication of more UEs than either alone.

In a first example, the same content can be transmitted on both PEI/WUS and paging-PDCCH (e.g., on “Reserved bits” as described in Example 7). A UE that supports PEI/WUS, can utilize PEI/WUS to get the paging group indication and CSI-RS resource availability indication. Hence, it can save more power by receiving one signal. If the UE misses reception of the PEI/WUS, then it can utilize paging-PDCCH to receive the paging group indication and CSI-RS resource availability indication. In addition, if a UE can receive both PEI/WUS and paging-PDCCH, then the reliability of indication information can be improved.

In second example, a subset of paging group indications and CSI-RS resource availability indication information can be carried on PEI/WUS and paging-PDCCH. For example, the paging group indication can be carried on PEI/WUS while the CSI-RS resource availability indication is carried on paging-PDCCH. In another example, if a paging group indication requires 3 bits and a CSI-RS resource availability indication also requires 3 bits, then the PEI/WUS can carry 3 bits of the paging group indication and one bit of the CSI-RS resource availability indication while the paging-PDCCH can carry 2 bits of the CSI-RS resource availability indication. Hence, the subset of paging group indications and CSI-RS resource availability indication information for PEI/WUS is 3+1 bits while the sub-set of paging group indication and CSI-RS resource availability indication information for paging-PDCCH is 2 bits, in this case comprising CSI-RS resource availability information. Other bit distributions can be configured depending on how many bits each channel uses for paging or CSI-RS indication.

In another example, if a PEI/WUS is configured, a sub-set of CSI-RS resource availability indication information (e.g., one bit) can be carried on PEI/WUS while the rest of the CSI-RS resource availability indication information is carried on paging-PDCCH. The one bit of CSI-RS resource availability indication information carried on the PEI/WUS can indicate whether there is any change for CSI-RS resource availability indication information on paging-PDCCH, rather than indicating a CSI-RS resource directly. Alternatively, other subsets, besides a single bit, of CSI-RS resource availability indication information carried on the PEI/WUS can indicate whether there is any change for CSI-RS resource availability indication information on paging-PDCCH.

In some embodiments, a subset of CSI-RS resource availability indication information carried on a PEI/WUS can indicate whether the CSI-RS resource availability indication information is present on paging-PDCCH or not. Similarly, a subset of CSI-RS resource availability indication information carried on the paging-PDCCH can indicate whether CSI-RS resource availability indication information is present on PEI/WUS or not.

A subset of a paging group indication carried on the PEI/WUS can indicate whether the paging group indication is present on paging-PDCCH or not. Similarly, a sub-set of paging group indication carried on the paging-PDCCH can indicate whether the paging group indication is present on PEI/WUS or not.

A higher layer (e.g., via SIB) can indicate a subset of a paging group indication and CSI-RS resource availability indication information on PEI/WUS and paging-PDCCH. For example, a SIB can indicate 4 paging groups on PEI/WUS (e.g., 4 bit, one bit for each group) and 2 CSI-RS resources availability on PEI/WUS (e.g., 2 bit, one bit for each CSI-RS resource) while another 6 CSI-RS resources availability can be carried on paging-PDCCH.

In some embodiments, the following mapping table for paging group indication and CSI-RS resource availability indication.

| | | Operation (Separate indication of paging group and CSI- |
|---|---|---|
| Entry | Bits | RS resource) |
| 0. | 000 | None group is addressed. |
| | | There is no CSI-RS (i.e., all are unavailable). |
| 1. | 001 | The first group is addressed. |
| | | The first CSI-RS resource is available. |
| 2. | 010 | The second group is addressed. |
| | | The second CSI-RS resource is available. |
| 3. | 011 | The third group is addressed. |
| | | The third CSI-RS resource is available. |
| 4. | 100 | The 1^{st} and 2^{nd} group are addressed. |
| | | The first CSI-RS resource is unavailable. |
| 5. | 101 | The 3^{rd} and 4^{th} group are addressed. |
| | | The second CSI-RS resource is unavailable. |
| 6. | 110 | The 5^{th}, 6^{th}, 7^{th} and 8^{th} group are addressed. |
| | | The third CSI-RS resource is unavailable. |
| 7. | 111 | Addressing all groups |
| | | All the CSI-RS resources are available |

A subset of paging group and/or CSI-RS resource availability can transmitted on PEI/WUS. Alternatively a sub-set of paging group and/or CSI-RS resource availability is transmitted on paging-PDCCH of a PO. For example, the paging group and the first CSI-RS Resource availability is indicated on PEI/WUS while other CSI-RS Resource availability is indicated on paging-PDCCH.

Both paging-PDCCH indication and PEI/WUS (e.g., PDCCH-based PEI) indications can be enabled (e.g., via SIB or, higher layer signaling), e.g., duplication. Alternatively, paging PDCCH indication can disabled if a PEI/WUS (e.g., PDCCH-based PEI) indication is configured. Alternatively, a paging PDCCH indication can be disabled or enabled by a PEI/WUS (e.g., PDCCH-based PEI) indication. Alternatively, one or both of paging-PDCCH indications and PEI/WUS indications can be configured by higher layer. Alternatively, which one or both of paging-PDCCH indications and PEI/WUS indications can broadcasted in SIB.

These methods allow for greater flexibility when indicating paging group and/or CSI-RS resource availability.

### Example 9

In a CORESET that carries PDCCH or PDCCH-based PEI/WUS, the DM-RS will be transmitted together with the PDCCH or PDCCH-based PEI/WUS. Hence, at the UE side, if a UE does not detect DM-RS on the target candidate CCE, this UE can assume that a PDCCH or PDCCH-based PEI/WUS is not transmitted. In some embodiments, if a UE does not detect DM-RS on the target candidate CCE, this UE can assume that a PDCCH-based PEI/WUS is not present.

A UE an perform other actions if it does not detect DM-RS on the target candidate CCE. For example, if a UE does not detect DM-RS on the target candidate CCE, this UE can assume that a state of CSI-RS availability is not changed. In another example, if a UE does not detect DM-RS on the target candidate CCE and the states of all the CSI-RS availability are jointly encoded, this UE can assume that a state of CSI-RS availability is not changed. Alternatively, if a UE does not detect DM-RS on the target candidate CCE and a codepoint represents a state of all the CSI-RS availability, this UE can assume that a state of CSI-RS availability is not changed.

A detection threshold can be defined for the DM-RS detection. For example, a detection threshold can be Th=−125 dBm. If a UE receives a DM-RS with power less than the detection threshold, this UE can assume a PDCCH-based PEI/WUS is not present (or any of the other assumptions/actions described above). For example, if a UE receives the DM-RS with a power of −130 dBm, then this UE can assume a PDCCH-based PEI/WUS is absent.

With this method, by detecting DM-RS while without decoding PDCCH in a CORESET, a UE can determine the presence of PDCCH-based PEI/WUS and/or CSI-RS availability.

### Example 10

In this example, a DM-RS can carry one bit or multiple bits (e.g., on its initialization seed, see the detailed example above). The bits on DM-RS can be jointly encoded with the bits in PDCCH (e.g., downlink control information, (DCI)).

For example, if there are N=8 groups to be addressed then the following table can be applied to indicate which group will be addressed. In this example, the codepoint plus one-th group will be addressed. This operation can be associated, for example, with a PO.

| Jointly encoding of | | Which group will | |
|---|---|---|---|
| bits in DCI and bits | | be addressed | |
| in DM-RS | Codepoint (C) | (woken up) | Expression |
| e.g., DM-RS | 0 | The first group | C + 1 |
| carries one bit as | 1 | The 2^{nd} group | C + 1 |
| MSB (or LSB) | 2 | The 3^{rd} group | C + 1 |
| while other bits | 3 | The 4^{th} group | C + 1 |
| come from DCI | 4 | The 5^{th} group | C + 1 |
| (e.g., 3 bits). Here, | 5 | The 6^{th} group | C + 1 |
| there are 4 bits in | 6 | The 7^{th} group | C + 1 |
| total (i.e., 2⁴ = 16 | 7 | The 8^{th} group | C + 1 |
| codepoints). | 8 | None. | N |
| | 9 | At least 2 groups | N + 1 |
| | . . . | Reserved state(s) | >N + 1 |
| | 15 | Reserved state(s) | (or, ≥N + 2) |

Note:
the meaning of codepoint = N and N + 1 can be mutual exclusive.

In some embodiments, the following table can be applied to indicate which group will be addressed.

| Jointly encoding of | | Which group will | |
|---|---|---|---|
| bits in DCI and bits | | be addressed | |
| in DM-RS | Codepoint (C) | (woken up) | Expression |
| e.g., DM-RS | 0 | None. | C + 1 |
| carries one bit as | 1 | The first group | C + 1 |
| MSB (or LSB) | 2 | The 2^{nd} group | C + 1 |
| while other bits | 3 | The 3^{rd} group | C + 1 |
| come from DCI | 4 | The 4^{th} group | C + 1 |
| (e.g., 3 bits). Here, | 5 | The 5^{th} group | C + 1 |
| there are 4 bits in | 6 | The 6^{th} group | C + 1 |
| total (i.e., 2⁴ = 16 | 7 | The 7^{th} group | C + 1 |
| codepoints). | 8 | The 8^{th} group | N |
| | 9 | At least 2 groups | N + 1 |
| | . . . | Reserved state(s) | >N + 1 |
| | 15 | Reserved state(s) | (or, ≥N + 2) |

Note:
the meaning of codepoint = N and N + 1 can be mutual exclusive.

The “Reserved state(s)” in the above tables can indicate CSI-RS availability. For example, a codepoint value 10 can represents that none of CSI-RS resource is available. In another example, a codepoint value 11 can represents that all CSI-RS resources (set) are available.

One or more bits of the joint bits of DM-RS and DCI can indicate CSI-RS availability. For example, the most significant bit (MSB) can represent CSI-RS resource availability (e.g., “0” for none of CSI-RS resource is available while “1” for all of CSI-RS resources (set) are available).

In another example, DM-RS can indicate wake up indication, i.e., which paging group will be addressed, while the bits in DCI can indicate CSI-RS resources availability.

In another example, DM-RS can indicate CSI-RS resource availability while the bits in DCI indicate wake up/paging indications.

### Example 11

The operation of multiple POs can be jointly expressed as a combination of bits in DCI and bits in DM-RS, such as jointly encoded bits. For example, the first 4 bits in the joint bits of bits in DCI and bits in DM-RS can indicate the operation of the first PO, and the second 4 bits in the joint bits of bits in DCI and bits in DM-RS can indicate the operation of the second PO.

In some embodiments, a DM-RS can indicate which PO is addressed. For example, one bit of a DM-RS correspond to a PO. Alternatively, a codepoint of some bits in a DM-RS can indicate which PO is addressed (woken up). A codepoint of some bits in a DM-RS can indicate one or more groups of one or more more POs that are addressed.

Similarly, the bit(s) in DCI can be used instead of the bits in DM-RS. For example, for paging group indication information for each PO, there can be a bit block in DCI that addresses one or more groups or subgroups. As described in this document, the bit block can address the groups or subgroups using a bitmap, a codepoint, or joint encoding.

For example, a “Reserved state(s)” similar to that in Example 10 can indicate CSI-RS availability.

In another example, one or more bits in the joint bits of DM-RS and DCI can indicate CSI-RS availability.

In another example, DM-RS can indicate wake up indication, i.e., which paging group will be addressed, while the bits in DCI can indicate CSI-RS resources availability.

In another example, DM-RS can indicate CSI-RS resources availability while the bits in DCI indicate wake up/paging indications.

### Example 12

A paging indication or CSI-RS resource availability indication can be carried in a bit scrambling code of a PDCCH-based PEI. After encoding and rate matching of PDCCH-based PEI, a bit sequence b(i) is achieved wherein i=0, 1, 2, . . . , M−1 where M is number of bits after rate matching. The bit sequence b(i) will be scrambled by a scrambling sequence c(i) such as c(i) described in the examples above. The bit scrambling operation can be as d(i)=b(i)⊕c(i) where ⊕ is modular-2 plus or XOR operation and the d(i) is the scrambled bit.

The paging indication information and/or CSI-RS resource availability indication can be used to generate the scrambling sequence c(i). For example, the scrambling sequence c(i) can be initialized with an initialization seed cᵢₙᵢₜ=(n_{RNTI}·2¹⁶+n_{ID}+n_{Group}*2⁸+n_{CSIRS}) mod 2³¹ where n_{RNTI} is a radio network temporary identity (e.g., it can be configured as paging RNTI, a value of 0x FFFE or, zero), n_{ID} is a parameter configured by higher layer (e.g., zero), the n_{Group} is the paging group indication (e.g., a value with 8 bits, such as 100), and n_{CSIRS} is the CSI-RS resource availability indication (e.g., a value with 12 bits, such as 200. This value can be an entry or codepoint of a table similar to those discussed in Example 6, with a different number of bits.) In addition, n_{RNTI} and n_{ID} can also be absent in the initialization seed.

| Entry | Bits | Operation |
|---|---|---|
| 0. | 000 | None group is addressed. |
| 1. | 001 | The first group is addressed. |
| 2. | 010 | The second group is addressed. |
| 3. | 011 | The third group is addressed. |
| 4. | 100 | The fourth group is addressed. |
| 5. | 101 | The 1^{st}, 2^{nd}, 3^{rd} and 4^{th} group are |
| | | addressed or, |
| | | any two groups are addressed. |
| 6. | 110 | The 5^{th}, 6^{th}, 7^{th} and 8^{th} group are |
| | | addressed or, |
| | | any three groups are addressed. |
| 7. | 111 | Addressing all groups |

After decoding a PDCCH-based PEI/WUS, a UE can get the value of n_{Group} and/or n_{CSIRS}. Hence, this UE can know which group will be addressed and/or CSI-RS resource availability. This method allows a UE to determine which group will be paged and/or which CSI-RS resources will be available. Hence, this can save power consumption of UE by maximizing sleep.

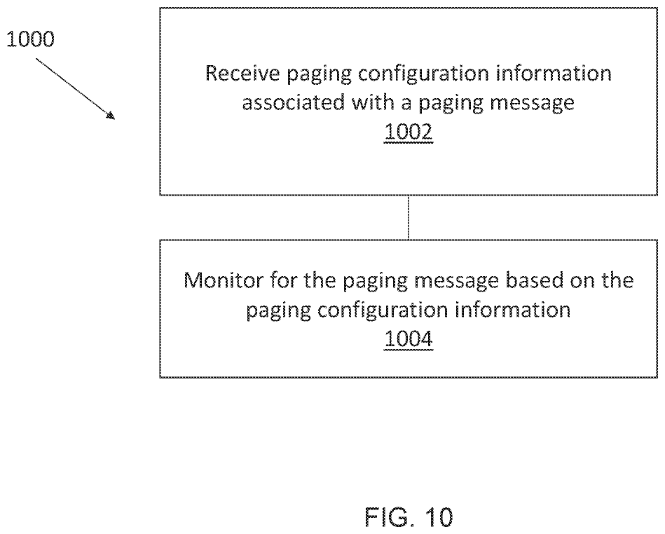

FIG. 10 shows an example method 1000. At 1002, paging configuration information is received. The paging configuration information can be associated with a paging message. For example, the paging configuration can include a paging indication channel and/or a paging occasion. The paging configuration information can indicate a paging probability for one or more groups. In some embodiments, the paging probability can be included in an entry of a configuration entity. The paging configuration information can further include CSI-RS resource availability information. At 1004, the paging message is monitored for, based on the received paging configuration information. monitoring for the paging message based on the paging configuration information.

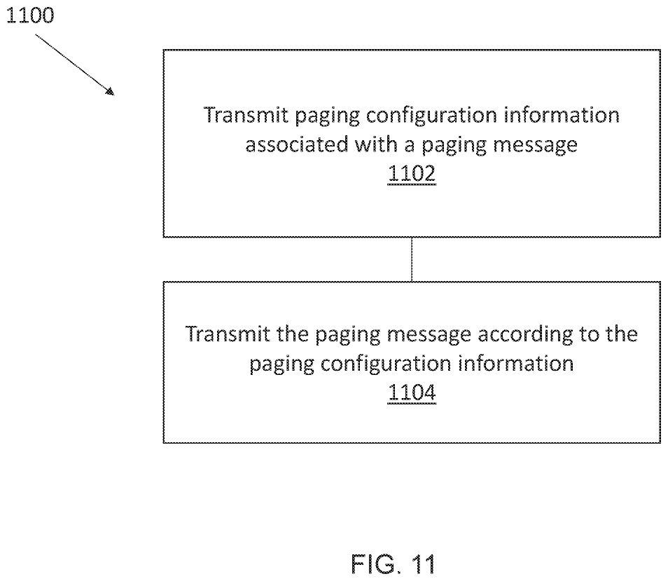

FIG. 11 shows an example method 1100. At 1102, paging configuration information associated with a paging message is transmitted. The paging configuration can include a paging indication channel and/or a paging occasion. The paging configuration information can indicate a paging probability for one or more groups. In some embodiments, the paging probability can be included in an entry of a configuration entity. The paging configuration information can further include CSI-RS resource availability information. At 1104, the paging message is transmitted according to the paging configuration information.

Some embodiments may preferably incorporate the following solutions as described herein.

For example, the solutions listed below may be used by wireless device implementations for paging as described herein:
1. A method of wireless communication (e.g. method 1000 of FIG. 10) comprising: receiving, at a wireless device, paging configuration information associated with a paging message (1002); and monitoring for the paging message based on the paging configuration information (1004).
2. The method of solution 1, wherein the paging configuration information indicates a paging indication channel and a paging occasion.
3. The method of solution 1, further comprising: receiving the paging message according to the paging configuration information.
4. The method of solution 1, wherein the paging configuration information includes a configuration entity associated with one or more groups (e.g., bit field structures 500, 600, 700, 800, or 900 of FIGS. 5-9).
5. The method of solution 4, wherein an entry of the configuration entity includes a paging probability of the one or more groups.
6. The method of solution 5, wherein the entry includes the paging probability of a single group, and wherein the paging probability of the single group is higher than that of a second group.
7. The method of solution 4, wherein the configuration entity comprises a variable number of entries or a plurality of predefined configuration sub-entities.
8. The method of solution 4, wherein the configuration entity is associated with a device type.
9. The method of any of solutions 1 to 8, wherein the paging configuration information includes channel state information reference signal (CSI-RS) resource availability information.
10. The method of solution 9, wherein a paging indication channel is configured and a subset of the CSI-RS resource availability information is carried on the paging indication channel.
11. The method of solution 10, wherein the subset of the CSI-RS resource availability information indicates a change in CSI-resource availability on paging-PDCCH.
12. The method of solution 1, wherein the paging configuration information indicates N paging occasions and M groups and comprises a bit structure (e.g., bit structure 600 of FIG. 6) including: a first block of N bits, each of the N bits associated respectively with one of the N paging occasions; and a plurality of blocks of M bits, wherein each of the plurality of blocks of M bits is associated with one of the N bits of the first block and is present only if the associated bit of the first block has a particular value.
13. The method of solution 1, wherein the paging configuration information indicates N paging occasions and comprises a bit structure (e.g., bit structure 500 of FIG. 5) including: N blocks of M bits each, each of the N blocks associated one of the N paging occasions, wherein each of the M bits is associated with a group.
14. The method of solution 1, wherein the paging configuration information comprises a bit structure (e.g., bit structure 900 of FIG. 9) including: a plurality of blocks associated with paging indication; and Q bits indicating an availability of a set of CSI-RS resources.
15. The method of solution 14, wherein each of the Q bits indicates whether a corresponding set of CSI-RS resources is available.
16. The method of solution 14, wherein the availability of the CSI-RS resource is indicated by a code point comprising the Q bits.
17. The method of solution 14, wherein the paging configuration information indicates greater than Q sets of CSI-RS resources, the method further comprising: performing a predefined operation to the Q bits.
18. The method of solution 17, wherein: the predefined operation is a modulo operation, and a kl set of CSI-RS resources is indicated by a q^{th} bit of the Q bits, wherein q=1+mod((k−1,Q).
19. The method of solution 1, wherein the paging configuration information is based on a secondary synchronization signal (SSS) and occupies a Control Resource Set (CORESET) resource in an interleaved manner.
20. The method of solution 19, wherein the paging configuration information is first mapped in a frequency domain, then mapped in a time domain.
21. The method of solution 19, wherein the CORESET resource includes a number of control channel elements (CCEs), each CCE including a number of resource elements (REs), and wherein a length of the SSS-based configuration information is not equal to a multiple of the number of resource elements in each CCE, the method further comprising: adding one or more zeroes on each end of the configuration information.
22. The method of solution 19, wherein the CORESET resource includes a number of control channel elements (CCEs), each CCE including a number of resource elements (REs), and wherein a length of the SSS-based configuration information is not equal to a multiple of the number of resource elements in each CCE, the method further comprising: setting one or more RE as zero.
23. The method of solution 19, wherein a CCE number is interleaved according to its resource block (RB) index, resource element group (REG) index, or REG bundle index.
24. The method of solution 1, wherein the paging configuration information includes CSI-RS configuration information.
25. The method of solution 24, wherein the CSI-RS configuration information comprises a default value.
26. The method of solution 24, wherein the CSI-RS configuration information comprises a plurality of fields that can be combined into one field.
27. The method of solution 24, wherein the CSI-RS configuration information indicates quasi-co-location (QCL) information based on a number of configured CSI-RS resources.
28. The method of solution 1, further comprising:
determining the presence of the paging configuration information by detecting a demodulation reference signal (DM-RS).
29. The method of solution 28, wherein the presence of the paging configuration information is determined when the detected DM-RS exceeds a threshold value.
30. The method of solution 28, wherein bits in downlink control information (DCI) and bits in DM-RS are jointly encoded, and wherein the jointly encoded bits indicate a paging group.
31. The method of solution 31, wherein the jointly encoded bits indicate the paging group based on a codepoint.
32. The method of solution 28, wherein bits in downlink control information (DCI) and bits in DM-RS are jointly encoded, and wherein the jointly encoded bits indicate a CSI-RS availability.
33. The method of solution 1, wherein the paging configuration information is received in a bit scrambling sequence.
34. The method of solution 24, wherein the CSI-RS configuration information is received in a bit scrambling sequence.
35. A method of wireless communication comprising: transmitting, by a network device, paging configuration information associated with a paging message; and transmitting the paging message according to the paging configuration information.
36. The method of solution 35, wherein the paging configuration information indicates a paging indication channel and a paging occasion.
37. The method of solution 35, wherein the paging configuration information includes a configuration entity associated with one or more groups.
38. The method of solution 35, wherein an entry of the configuration entity includes a paging probability of the one or more groups.
39. The method of solution 38, wherein the entry includes the paging probability of a single group, and wherein the paging probability of the single group is higher than that of a second group.
40. The method of any of solutions 35 to 39, wherein the paging configuration information includes channel state information reference signal (CSI-RS) resource availability information.
41. The method of solution 35, wherein the paging configuration information indicates N paging occasions and M groups and comprises a bit structure including:
a first block of N bits, each of the N bits associated respectively with one of the N paging occasions; and a plurality of blocks of M bits, wherein each of the plurality of blocks of M bits is associated with one of the N bits of the first block and is present only if the associated bit of the first block has a particular value.
42. The method of solution 35, wherein the paging configuration information indicates N paging occasions and comprises a bit structure including: N blocks of M bits each, each of the N blocks associated one of the N paging occasions, wherein each of the M bits is associated with a group.
43. The method of solution 35, wherein the paging configuration information is based on a secondary synchronization signal (SSS) and occupies a Control Resource Set (CORESET) resource in an interleaved manner.
44. The method of solution 35, wherein the paging configuration information includes CSI-RS configuration information.
45. The method of solution 44, wherein the CSI-RS configuration information comprises a default value.
46. The method of solution 44, wherein the CSI-RS configuration information comprises a plurality of fields that can be combined into one field.
47. The method of solution 44, wherein the CSI-RS configuration information indicates quasi-co-location (QCL) information based on a number of configured CSI-RS resources.
48 An apparatus for wireless communication comprising a processor configured to implement the method of any of solutions 1 to 47.
49. A computer readable medium having code stored thereon, the code when executed by a processor, causing the processor to implement a method recited in any of solutions 1 to 47.

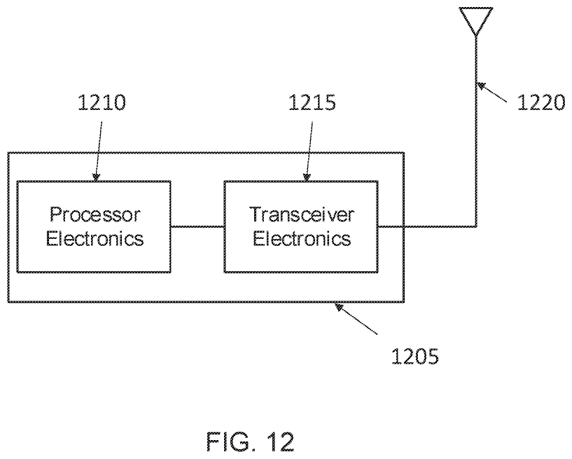

FIG. 12 is a block diagram representation of a portion of an apparatus, in accordance with some embodiments of the presently disclosed technology. An apparatus 1205 such as a network device or a base station or a wireless device (or UE), can include processor electronics 1210 such as a microprocessor that implements one or more of the techniques presented in this document. The apparatus 1205 can include transceiver electronics 1215 to send and/or receive wireless signals over one or more communication interfaces such as antenna(s) 1220. The apparatus 1205 can include other communication interfaces for transmitting and receiving data. Apparatus 1205 can include one or more memories (not explicitly shown) configured to store information such as data and/or instructions. In some implementations, the processor electronics 1210 can include at least a portion of the transceiver electronics 1215. In some embodiments, at least some of the disclosed techniques, modules or functions are implemented using the apparatus 1205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1-49. (canceled)

50. A method of wireless communication comprising:
prior to receiving a paging message, receiving, at a wireless device, paging configuration information,
wherein the paging configuration information includes a paging indication comprising N*M bits followed immediately by a Channel State Information Reference Signal (CSI-RS) resource availability indication comprising Q bits, wherein N, M, and Q are integers;
monitoring for the paging message based on the paging indication; and
receiving a CSI-RS according to the CSI-RS resource availability indication.

51. The method of claim 50, wherein N is a number of paging occasions (POs) associated with the paging indication; wherein M is a number of PO groups within each of the POs; wherein each of the N*M bits is associated with a respective PO group of the PO groups; and wherein for each of the N*M bits, a value of 1 indicates the associated PO group is paged, and a value of 0 indicates the associated PO group is not paged.

52. The method of claim 50, wherein each of the Q bits indicates whether a corresponding CSI-RS resource set is available.

53. The method of claim 52, wherein a bit of the Q bits having a value of 1 indicates that a CSI-RS resource set corresponding to the bit having the value of 1 is available.

54. The method of claim 50, wherein the CSI-RS is a tracking reference signal (TRS).

55. A method of wireless communication comprising:
prior to transmitting a paging message, transmitting, by a network device, paging configuration information,
wherein the paging configuration information includes a paging indication comprising N*M bits followed immediately by a Channel State Information Reference Signal (CSI-RS) resource availability indication comprising Q bits, wherein N, M, and Q are integers,
wherein the paging indication is configured for use by the wireless device to monitor for the paging message;
transmitting the CSI-RS resource according to the CSI-RS resource availability indication; and
transmitting the paging message according to the paging indication.

56. The method of claim 55, wherein N is a number of paging occasions (POs) associated with the paging indication; wherein M is a number of PO groups within each of the POs; wherein each of the N*M bits is associated with a respective PO group of the PO groups; and wherein for each of the N*M bits, a value of 1 indicates the associated PO group is paged, and a value of 0 indicates the associated PO group is not paged.

57. The method of claim 55, wherein each of the Q bits indicates whether a corresponding CSI-RS resource set is available.

58. The method of claim 57, wherein a bit of the Q bits having a value of 1 indicates that a CSI-RS resource set corresponding to the bit having the value of 1 is available.

59. The method of claim 55, wherein the CSI-RS is a tracking reference signal (TRS).

60. An apparatus for wireless communication comprising a processor and a memory storing instructions, execution of which by the processor causes the apparatus to:
prior to receiving a paging message, receive, at the apparatus, paging configuration information,
wherein the paging configuration information includes a paging indication comprising N*M bits followed immediately by a CSI-RS resource availability indication comprising Q bits, wherein N, M, and Q are integers;
monitor for the paging message based on the paging indication; and
receive a CSI-RS according to the CSI-RS resource availability indication.

61. The apparatus of claim 60, wherein N is a number of paging occasions (POs) associated with the paging indication; wherein M is a number of PO groups within each of the POs; wherein each of the N*M bits is associated with a respective PO group of the PO groups; and wherein for each of the N*M bits, a value of 1 indicates the associated PO group is paged, and a value of 0 indicates the associated PO group is not paged.

62. The apparatus of claim 60, wherein each of the Q bits indicates whether a corresponding CSI-RS resource set is available.

63. The apparatus of claim 62, wherein a bit of the Q bits having a value of 1 indicates that a CSI-RS resource set corresponding to the bit having the value of 1 is available.

64. The apparatus of claim 60, wherein the CSI-RS is a tracking reference signal (TRS).

65. An apparatus for wireless communication comprising a processor and a memory storing instructions, execution of which by the processor causes the apparatus to:
prior to transmitting a paging message, transmit, by the apparatus, paging configuration information,
wherein the paging configuration information includes a paging indication comprising N*M bits followed immediately by a CSI-RS resource availability indication comprising Q bits, wherein N, M, and Q are integers,
wherein the paging indication is configured for use by a wireless device to monitor for the paging message;
transmit the CSI-RS resource according to the CSI-RS resource availability indication; and
transmit the paging message according to the paging indication.

66. The apparatus of claim 65, wherein N is a number of paging occasions (POs) associated with the paging indication; wherein M is a number of PO groups within each of the POs; wherein each of the N*M bits is associated with a respective PO group of the PO groups; and wherein for each of the N*M bits, a value of 1 indicates the associated PO group is paged, and a value of 0 indicates the associated PO group is not paged.

67. The apparatus of claim 65, wherein each of the Q bits indicates whether a corresponding CSI-RS resource set is available.

68. The apparatus of claim 67, wherein a bit of the Q bits having a value of 1 indicates that a CSI-RS resource set corresponding to the bit having the value of 1 is available.

69. The apparatus of claim 65, wherein the CSI-RS is a tracking reference signal (TRS).
